(19) United States
(12) Patent Application Publication
(10) Pub. No.: US 2003/0029977 A1
(43) Pub. Date: Feb. 13, 2003

(54) CYLINDER SUPPORT BRACKET

(76) Inventor: Jack T. B. Kim, San Jose, CA (US)

Correspondence Address: Jack T. B. Kim, 3440 Sierra Road, San Jose, CA, 95132, US

(21) Appl. No.: 09/885,184

(22) Filed: Jun. 21, 2001

(51) Int. Cl. F16B 1/00; A47B 96/06

(52) U.S. Cl. 248/230.8

(57) ABSTRACT

A bracket for restraining a compressed gas cylinder in an upright position against a wall, said bracket being adjustably secured to a horizontal strut. The strut is a channel with inward curved lips along its tip and slots on the bottom of the channel to allow the strut to be attached to a wall. The strut nuts and strut bolts adjustably connect the bracket to the strut. The bracket secures the compressed gas cylinder to the bracket. More than one bracket can be attached to the strut.

### FIELD OF INVENTION

This invention relates generally to the field of wall attachment fixtures and more particularly to the field of safety securement devices for the support and securement of compressed gas cylinders to a wall. The field includes a wide variety of securement devices including fixtures with straps and brackets. These devices are typically attached to walls having support means comprised of interior wood frame members or to concrete walls.

The present invention utilizes a new attachment means for such devices. A commercially available metal strut, in common use in industry, is utilized with attachment means commonly called strut nuts and strut bolts to affix such a bracket along the length of the strut. This ability to attach the strut, normally in a horizontal position, to a wall, and then to allow the bracket to be affixed at an adjustable position along the strut constitutes the present invention.

### PRIOR ART

No prior art can be found which discloses the present invention.

### CROSS-REFERENCES

None

### STATEMENT REGARDING THE USE OF FEDERAL FUNDS

No federal funding, direct or indirect, has been utilized in conjunction with the development of the present invention.

### STATEMENT REGARDING MICROFISCHE RECORDS

No microfische records are used in the application submitted for the present invention.

### SUMMARY OF THE INVENTION

The present invention permits the attachment of a special bracket to a wall using a strut, whose cross section is a channel, with adjustable strut nuts and strut bolts. The special bracket allows for the temporary securement of one or more compressed gas cylinders in an upright position against a wall. The strut is attached to a wall using lag bolts when the wall has interior wood framing and using commercial concrete bolts when the wall is made of concrete. Once attached to the wall roughly 3 feet above the floor, the bracket can be attached to the strut using strut nuts and strut bolts. The strut nuts are captured by the inward curved lips on either side of the channel-shaped strut along its length. The strut bolts are fed through holes in the bracket and are loosely screwed into the strut nuts. The bracket can then be slid along the strut to a suitable position on the strut. Then the strut bolts are tightened to the strut nuts thus securing the bracket. The compressed gas cylinder is secured to the bracket using a strap or chain which is integral to the bracket.

Commercial struts of this type are produced with a cross section comprising a shallow channel or a deeper channel. If the deeper channel is used, then the strut nuts will clear the heads of lag bolts when the position of the bracket is being adjusted. With the shallow channel, the adjustment is limited to a shorter range as the heads of the lag bolts contact the strut nuts.

In the preferred embodiment of the present invention, the bracket is made of a single piece of metal, preferrably stainless steel, which is comprised of a narrow band of steel plate with perforations for the strut bolts and for the securement means for a compressed gas cylinder. Said securement means are comprised of either a strap and buckle or chains attached to the sides of the bracket. In the preferred embodiment of the present invention, said bracket is formed from a strip of steel plate about 1.75 inches wide.

These and other objects and advantages of the present invention will become clear to those skilled in the art in view of the description of the best presently known mode of carrying out the invention and the applicability of the preferred embodiment as described here in and as illustrated in the several figures of the drawings.

### DESCRIPTION OF THE DRAWINGS

FIG. 1 is a perspective view of two brackets mounted to a strut which is attached to a vertical wall, one of which brackets secures a compressed gas cylinder.

FIG. 2 is an end view of a strut and a bracket.

FIG. 3 A perspective view of a bracket.

### CYLINDER SUPPORT BRACKET—SPECIFICATION

Best Mode for Carrying Out Invention

The best mode for carrying out the present invention is the Cylinder Support Bracket which permits the secure attachment of one or more conventional compressed gas cylinders to a wall. The invention will now be described in detail, including the preferred embodiment thereof.

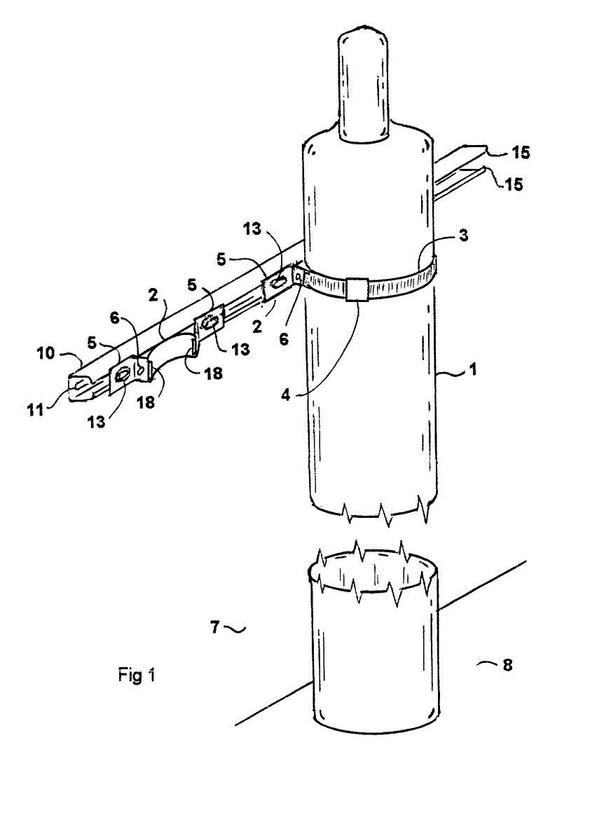

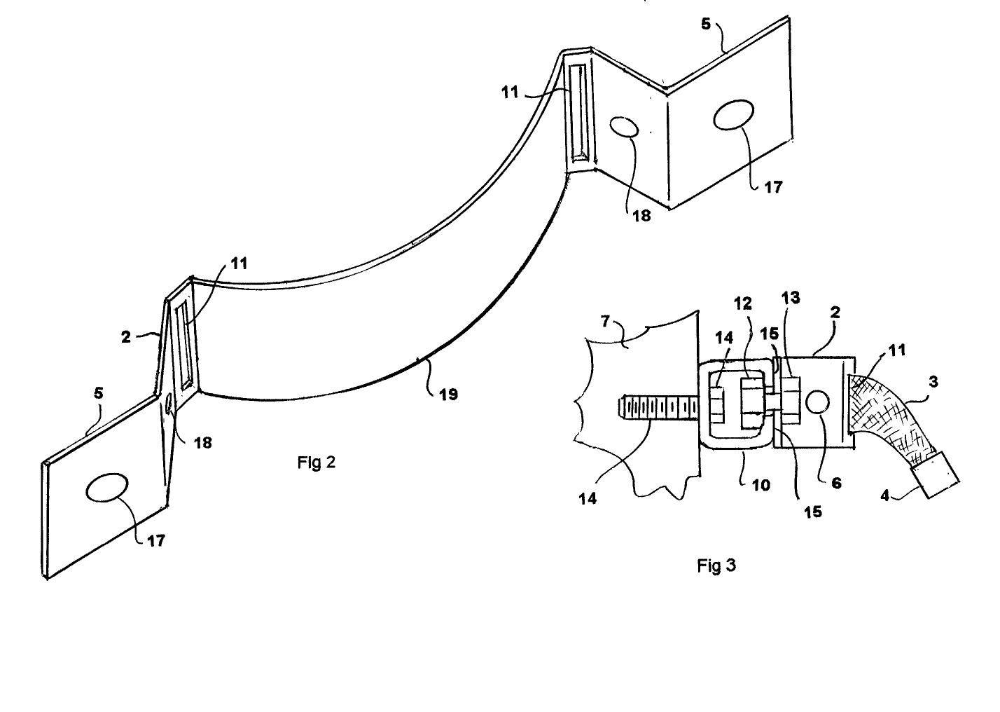

FIG. 1 illustrates a conventional strut 10 having slots 11 in the base through which lag bolts 14 or other securing means affix said strut 10 to a wall 7 as shown in FIG. 2, said strut 10 is comprised of a length of material, a conventional channel shape, the legs of which are curved inward, comprising curved lips 15, toward the base of the strut 10, said curved lips 15 restrain strut nuts 12 from moving away from said strut 10, while affixing a bracket 2 to said strut 10 with strut bolts 13 as shown in FIGS. 1 and 2. In the preferred embodiment of the present invention, said strut nuts 12 are free to move along the inside of said strut 10 clear of said lag bolts 14. Said bracket 2, in the preferred embodiment of the present invention is made of a single piece of rigid flat material with outer flanges 5, each of which is centrally perforated with a flange hole 17 through which said strut bolts 13 affix said bracket 2 to said strut 10 by means of said strut nuts 12. Said flat material is in the preferred embodiment comprised of stainless steel. The center portion of said bracket 2, a cylindrical section 16, conforms to the shape of a conventional compressed gas cylinder 1 as shown in FIG. 1, with said center cylindrical section 16 continuously connected at its ends to said flanges 5 as shown in FIGS. 1 and 3. A strap slot 18 in said bracket 2 at each of the distal ends of said cylindrical section 16 contain a securing strap 3, said strap 3 having securement means, a buckle 4, for securing said cylinder 1 to said bracket 2 as shown in FIG. 1.

FIG. 3 illustrates said bracket 2, said flanges 5, said flange holes 17 in said flanges 5, said strap slots 18 near the distal ends of said cylindrical section 16 and chain holes 6 in the bracket 2 between each of said strap slots 19 and said flanges 5. Said chain holes 6 provide an alternate means for attachment of said cylinder 1 to said bracket 2 when link chains, not shown, are attached to said chain holes 6. The normal usage of the present invention is with said cylinder 1 resting on the floor 8 as shown in FIG. 1.

The manner of utilizing the present invention will now be described. The strut nuts 12 move freely within and along said strut 10 and permit the location of the bracket 2 along and on the strut 10 independent of the position of the strut 10 on the wall 7, thereby allowing the bracket 2 and subsequently a cylinder 1 to be affixed to the wall 7 in a convenient manner. When affixed to a wood frame wall, said lag bolts 14 can be driven into the studs to give strong support without constraining the final position of said brackets 2 and cylinders 1. Other conventional means of attachment of the strut 10 to the wall such as concrete anchors can be used as would be obvious to one skilled in the art.

Thus it has been shown that the bracket 2 can be affixed to a wall 7 by allowing the bracket 2 to slide horizontally along said strut 10, which has been affixed to a wall 7, until a preferred position has been found. When the desired position for a bracket 2 has been located along the strut 10, said strut bolts 13 are affixed to said strut nuts 12 located along the interior of said strut 10 thus securing said bracket 2 to the strut 10. Thus the present invention permits one or more brackets 2 and cylinders 1 to be conveniently and adjustably attached to said strut 10 as shown in FIG. 1. The present invention comprises this adjustable feature of installation which is not taught by prior art and which is not evident in the securement of compressed gas cylinders.

All of the above are only some of the examples of available embodiments of the present invention. Those skilled in the art will readily observe that numerous other modifications and alterations may be made without departing from the spirit and scope of the invention. Accordingly, the above disclosure is not intended as limiting and the appended claims are to be interpreted as encompassing the entire scope of the invention.

Reference Numerals—Description

Numeral Description

1. Cylinder

2. Bracket

3. Strap

4. Buckle

5. Flange

6. Chain hole

7. Wall

8. Floor

9. Hole, securing

10. Strut

11. Slot

12. Strut nut

13. Strut bolt

14. Lag bolt

15. Curved lip

16. Cylindrical section

17. Flange hole

18. Strap slot

What is claimed is:

1. An apparatus for securing compressed gas cylinders upright against a wall comprised of a bracket, a strut, an adjustable attachment means attaching said bracket to said strut, an adjustable securement means securing said strut to a wall and restraining means affixing said gas cylinder to said bracket.

2. Adjustable attachment means as in claim 1 comprised of strut nuts and strut bolts.

3. Adjustable securement means as in claim 1 comprised of lag bolts.

4. Adjustable securement means as in claim 1 comprised of concrete anchors.

5. Restraining means as in claim 1 comprised of a strap or chains.

6. An apparatus as in claim 1 comprised of more than one bracket.
